(19) United States
(12) Patent Application Publication
(10) Pub. No.: US 2020/0242174 A1
(43) Pub. Date: Jul. 30, 2020

(54) METHODS AND SYSTEMS FOR FACILITATING PROCUREMENT OF CONSTRUCTION GOODS AND SERVICES

(71) Applicants: Karen Biran, Redmond, WA (US); Yahav Biran, Redmond, WA (US); Grant Burry, Boulder, CO (US)

(72) Inventors: Karen Biran, Redmond, WA (US); Yahav Biran, Redmond, WA (US); Grant Burry, Boulder, CO (US)

(21) Appl. No.: 16/602,026

(22) Filed: Jul. 24, 2019

Related U.S. Application Data
(60) Provisional application No. 62/918,309, filed on Jan. 25, 2019.

(51) Int. Cl. G06F 16/957; G06F 16/953; G06F 16/901; G06F 16/9035

(52) U.S. Cl. CPC G06F 16/957; G06F 16/9035; G06F 16/9027; G06F 16/953

(57) ABSTRACT

The present invention relates to an online platform system provides various features for facilitating construction commerce and assisting customers with effectively manage construction projects. By offering numerous trade features via a consolidated system, customers are now able to efficiently manage communication between parties regarding potential trade, connect with construction vendors to initiate and complete transactions for the procurement of construction goods and services. The invention will assist customers to facilitate various processes associated with the sale, listing requests for construction good or service based on the specific requirements of the job, and efficiently manage proposals. After an agreement is reached between the consumer and vendor, the system provides services to complete a transaction for the procurement of the goods and services.

### BACKGROUND OF THE INVENTION

### Field of the Invention

The present invention relates to an online platform that allows for the connection of consumers and construction vendors for assisting with effectively manage construction projects. The system provides features to generate proposals upfront for construction good or service based on the specific requirements of the job and efficiently manage the proposals. By offering various trade features via a consolidated system, vendors and consumers are now able in real time to propose and receive proposals; initiate and complete negotiations, proceeding with deals, and other processes associated with construction sales. The invention will assist customers to facilitate efficient communication between parties regarding potential trade offering users a convenient procurement experience. More specifically, the invention relates to user interfaces and methods through which users may list desired construction assets for purchase, receive proposals offered by vendors, perform payments, and conduct related actions within the platform.

### Description of the Background Art

The present invention generally relates to systems and methods for facilitating procurement of construction goods and services between consumers and construction vendors in an online platform.

Facilitating construction commerce requires the involvement of multiple proposals offered to customers by vendors for the purchase of a construction asset. Construction assets can consist of goods, services, or a combination of goods and services. In order to initiate and complete a transaction a consumer is required to search and coordinate with disparate vendors (e.g. contractors, subcontractors, design professionals, machinery rental services, consultants, etc.). Consumers often receive multiple proposals for each desired construction asset in order to identify the best proposal for their search parameters, such as price range, availability, and product quality. As described above, the consumer would typically receive multiple proposals and perform a relatively complicated process when attempting to manage proposals from vendors.

Currently there are many difficulties to performing an efficient search for construction proposals with traditional sales channels which may include “brick-and-mortar” retail stores or websites with similar product offerings. When using these channels, proposals are received manually through electronic mail or phone and the consumer typically must hire extra staff to search through, evaluate, and manage proposals and to keep all project information organized. As a result, significant time and money is spent on administrating procurement.

In a more general and more common process, the current system known to use a cross-platforms operation to manage construction procurement. As such, in order for customers to complete a deal, each action of the process associated with the sale must be done via disparate platform. In an example, users may search for assets within a search engine across various websites. Proposals are sent via email that may be also used to process negotiation, exchange relevant information and documentation based on the specific requirements of the job. After evaluating the proposal, additional platform may use to generate a contract. Conventionally, performing the sale process across different platforms may not be effective, and may increase complexity and cost.

Accordingly, it is believed that a need exists for improvement in such systems. This, and other needs, are addressed by the present invention. It is believed that the invention, an electronic platform for facilitating construction commerce, provides an efficient system in which consumers and vendors may be brought together for procuring goods and services. Described herein is an electronic platform that offers various trade features via a platform as such, vendors and consumers are now able to effectively manage construction trades and perform multiple actions associated with the sale via consolidated platform.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a data-flow diagram in an example architecture for operating environment that includes a service provider network that can be configured to implement aspects of the functionality described herein.

FIG. 2 is a block diagram illustrating applications in the platform according to an embodiment;

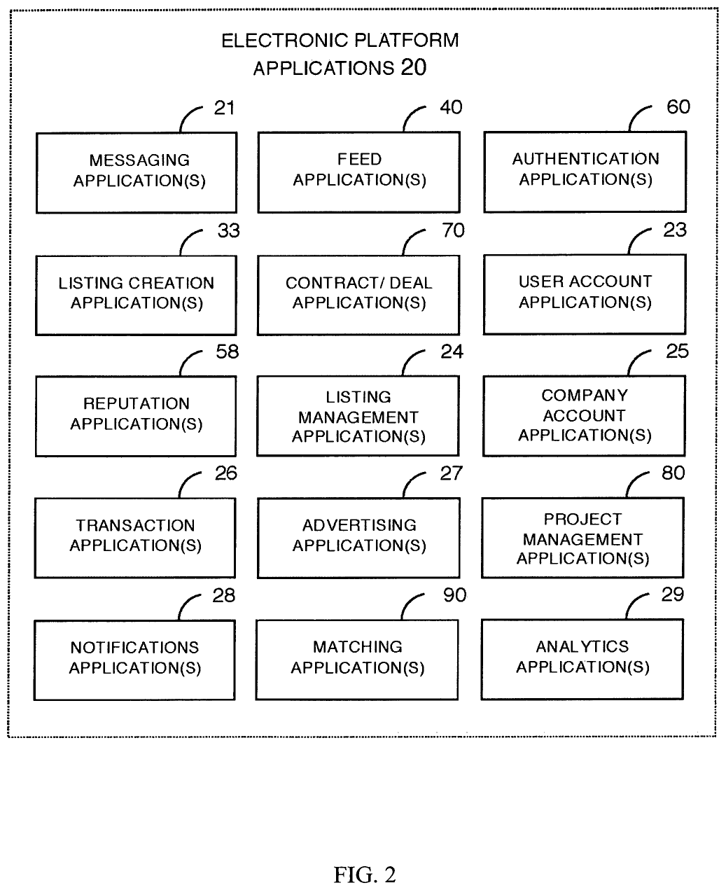

FIG. 3 illustrates an operational flow diagram of the procurement process in the platform;

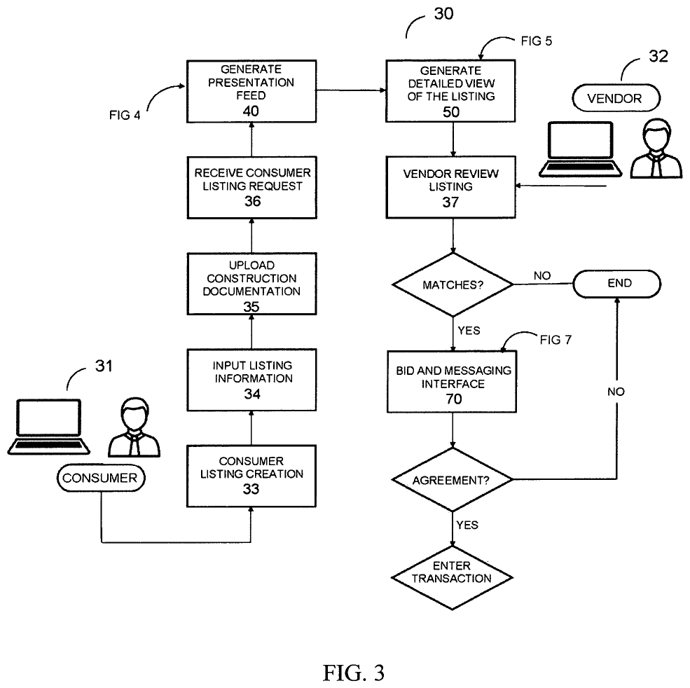

FIG. 4 illustrates an exemplary graphical user interface for presentation feeds of project listings in the platform;

FIG. 5 illustrates an exemplary graphical user interface for project detail page showing listing according to one embodiment of the invention;

FIG. 6 illustrates an operational flow diagram of the user authentication process in the platform;

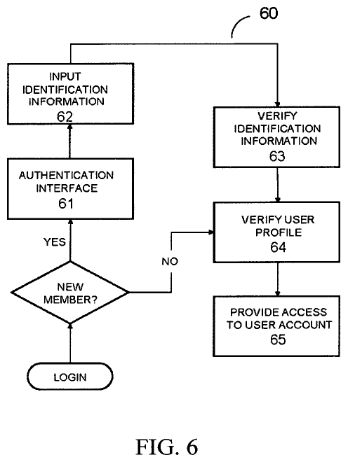

FIG. 7 schematically illustrates an exemplary graphical user interface for initiating a new contract/deal by vendor proposed to consumer;

FIG. 8 schematically illustrates an exemplary graphical user interface that a project owner is presented with project data, in which is stored by groups of various activities;

FIG. 9 schematically illustrates process of matching engine in the platform, wherein the application determines a common link between consumers and vendors and alerts the vendor of potential deals.

FIG. 10 illustrates an operational flow diagram of the deal process in the platform;

### DETAILED DESCRIPTION

Accordingly, it is believed that a need exists for improvement in such systems. This, and other needs, are addressed by the present invention. It is believed that the invention, an electronic platform application 21 for facilitating construction commerce, provides an efficient system in which consumers 31 and vendors 32 may be brought together for procuring goods and services. Described herein is an electronic platform that offers various trade features via a consolidated platform as such, vendors 32 and consumers 31 are now able to effectively manage construction commerce and perform multiple actions associated with the sale via unify platform.

The present invention includes many aspects and features. In a broad aspect, the invention is a website or a mobile application of a consolidated platform where consumers 31 and vendors 32 conduct commerce for construction goods and services. In accordance with the purposes of the invention as embodied and described in this document, a new method and system will assist users in efficiently initiating and completing a transaction for the purchase of a construction asset.

Participants in online platforms may include individuals, small companies, large corporations, or other types of construction organizations. In general, the term “consumer” 31 may refer to individuals or group of persons e.g. construction developers, real estate developers, project owners etc. The term “vendor” 32 may refer to individuals or group of persons e.g. distributor, contractor, subcontractor, manufacturer, consultant etc. Some participants in online platforms may have business-to-business (B2B) relationships. Other participants may have a business to-customer (B2C) relationship, in which a business may sell goods and services to an individual home owner.

Messaging Application 21

To achieve the purpose of the present invention the system provides features for facilitating communication between parties regarding a potential trade by which the vendor 32 and consumer 31 may negotiate, offer proposal, and other processes associated with the sale. The system may facilitate instant messaging application 21 allowing a user to launch a message to one or more users. The application may allow to conveniently exchange messages between the participants in a chat environment, upload and share attachments. Any participant can add a new participant at any point in the conversation and perform other operations such as: initiation of a chat conversation, removal of participants from the conversation, etc.

Another object of the invention may provide various features for assisting users in listing desired construction assets. A consumer 31 wishing to purchase an asset can create a listing of the asset request together with relevant information and documentation that vendors 32 may need to understand the request. The system receives the consumers 31 request into a database and generates a presentation of feed base listings 40. The feeds presentation may appear to the user as a webpage interface enabling potential vendors 32 to discover projects while processing a search for relevant request category. A browse application 42 may help users in searching and navigating various listings according to the location or category that matches the vendor's 32 asset available for sale. Moreover, the system may identify the current location of the user and accordingly the same current location may be utilized to select local listings nearby.

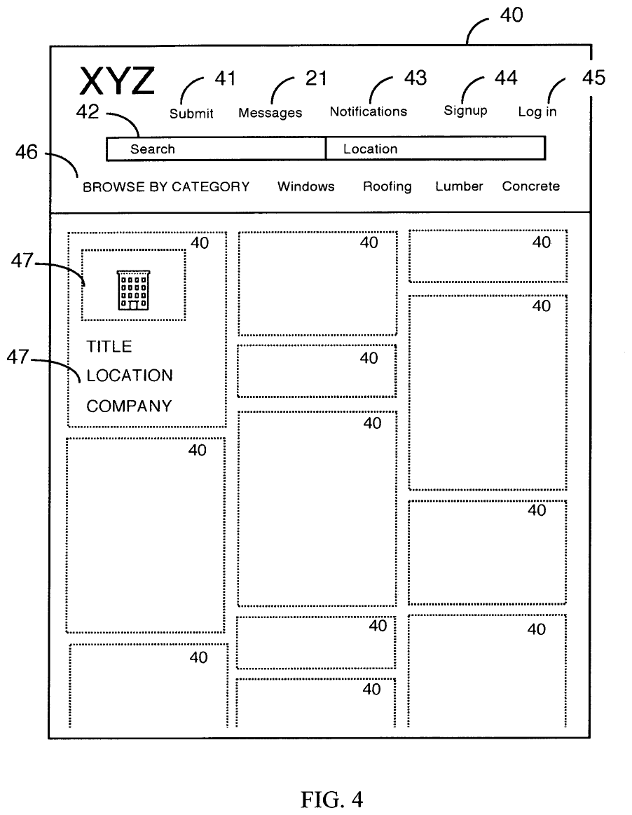

Feed Application FIG. 4

The website includes a home page comprising a feed-based presentation of listings 40 generated from plurality of source feeds where a consumer 31 or a vendor 32 are able to discover and review listings via the platform. Upon logging in a customer is presented with a homepage showing the feed presentation 40 in which the system may operate the presentation of a real time continuously generated feed. A feed may incorporate a preview of the listing including thumbnail image 47, project information 48 i.e. tittle, location, company, etc. and may be selectable by the user to perform actions such as a detailed view of the listing.

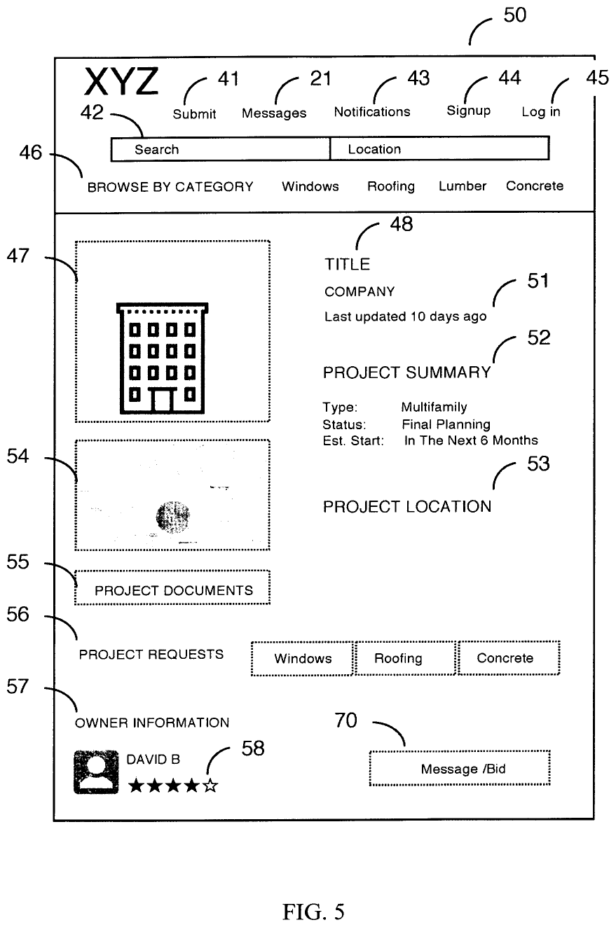

A detailed view of the listing FIG. 5 may appear as a webpage 50 and include graphical user interfaces that provide relevant information essential to understand the request and/or the relating construction project. The listing page 50 may present reference information associated with the project and the asset request in which may be available to support the trading. Such reference information may include uploaded images 47 and construction documentation 55, project information 48 e.g. title, company name, project location 54, recent listing history 51 (e.g. last updated 10 days ago), project summary 52 (e.g. type, status, estimated start date), project requests 56 comprising a detailed description of the construction asset request specifying the construction goods or services the listing owner wish to buy. Furthermore, the project location 54 may be presented on a geographic map display in which generated in accordance with the received address information. In particular, a visualization of the geographic project location may assist a user in identifying geographic area on a user interface.

Additionally, the listing owner information 57 profile may be available for inclusion within the listing. The information may be displayed on demand so that the user account data is presented together with personal identity, user history, rating parameter 58 that may be factored into the prioritization of the transaction or other reference information that may be publicly displayed to other potential trading partners for the purposes of assessing credibility and trustworthiness.

To facilitate the ability for users to communicate with the listing's owner regarding a potential trade, the listing page 50 may include “message/bid” button 70. By clicking the corresponding “message/bid” button 70 the system may generate a chat environment via the user interface contain the vendor 32 option to launch a message to the listing's owner, offer proposal, upload and share attachments and other processes associated with the sale.

Authentication Application 60

Another object of the invention may offer a user authentication application 60 wherein facilitates a security protocol. The system may be protected such that users need to be authenticated to corresponding user accounts, e.g., to determine that clients seeking access to resources “are who they say they are’ before access is permitted to the platform resources. A user sign-in may be configured for providing user access to perform plurality of functions through the platform and may require users to put in credentials, e.g., typing a username and password.

User Account 23

The system enables users to create a user account by supplying reference information concerning the background and/or personal identity associated with the user. Such user data may be stored in the user database 15 and one or more reference information may be available to other potential trading partners.

Reputation Application 58

Another object of the invention may offer a reputation application 58 for assisting users to establish, build and maintain reputation in the platform. The feature may also allow peer-to-peer feedback and/or feedback score, view user history or other reference information. The reputation profile 58 may be publicly displayed to other potential trading partners for the purposes of evaluating credibility and trustworthiness. The information may be displayed on demand so that the consumers 31 and vendors 32 are aware of the reputations prior to committing to a given transaction.

Listing Creation Application 33

Another object of the invention may offer a listing creation application 33 allowing consumers 31 to conveniently generate listings relating the construction goods or services they wish to buy. The listing creation 33 page may provide a fillable template via a user interface whereby the users are guided through a number of steps in an attempt to submit a construction asset request. A user wishes to initiate the listing may click “Submit” 41; the user will automatically be designated as an “owner” for that listing and may be allowed to perform one or more actions on the listing afterward. Such actions may be an option to edit the content, invite new members to be administrators for that listing, etc.;

The first step for creating a listing contain a number of fields that may filled-in with information concerning the construction project (e.g. project name, project type, address, estimated start, etc.). The process continues to step where users may upload construction documentation for inclusion within the listing e.g. images, construction drawings, specs, schedules, etc. The process continues to step where the user determines the desired assets within different product-related categories. The user can identify one or more construction assets he wishes to buy using product searches with the search engine interface. Alternatively, users can perform product searches using a browse tree interface organized into predetermined categories. After a user has located all desired assets, the final step may be submitting the asset to the platform by selecting the corresponding “Submit” button.

The product search assists users in locating construction assets that can be purchased. Due to the large number of construction assets users may be presented with groups of related assets categories configured in browse tree structure that may be utilized by various user interfaces. Users can pursue assets using a browse tree interface organized into predetermined categories such as building materials, subtractors, heavy machinery, etc.; In the structure of the browse tree a category is the highest level while each category may have multiple groups of related assets (referred to herein as “subcategories”). By clicking on the category name (e.g. building materials, subtractors, heavy machinery, etc.) the system may generate a presentation of subcategories which are the second stage filtering results in which includes related assets corresponding to the category. The second stage results may be followed by a third filtering stage and display sub-subcategories. These set of corresponding filtering stages may repeat one or more times until the user has located all desired assets.

The categories are based on the Construction Specification Institute's “MasterFormat,” the U.S. and Canadian standard for specifications and Project Manuals. Users can perform searches for construction products and services related to MasterFormat divisions within different product-related categories from which user-specified products can be purchased.

Alternatively, users may search for assets using a search engine interface by typing in the desired information (referred to herein as a “query’) into a query window and then clicking on a search initiation button. A search tool capable of generating search results from a database in response to a query submitted by a user. The search engine feature may be utilized by keywords that are received and generate query server to locate assets that are both relevant to a user's search request and likely to include a product offering.

Listing Management Application 24

After a user has submitted a listing, he may be able to manage the listing. Listing management applications may assist users with a number of activities that may typically occur post-listing. Such applications may provide interfaces to allow the user conveniently perform actions on the listing e.g. an option to edit the content, an option to provide further content, to delete the content, an option to invite new members to be administrators for that listing (e.g., if the user is designated as a “owner” for that listing for the system), etc.

Company Account Application 25

Another object of the invention may offer a company profile account for allowing individual members to be associated with an organization. Establishment of company profile can assist users in performing actions on behalf of the organization while collaborating with a plurality of participants in the platform. A company profile interface may include reference information concerning the company, such as the company's name, location, contact information, etc.; companies may also upload image of company logo, provide social media links etc.

The company profile may also include information concerning the company's reputation, history or other reference information which may be made available and published to potential trading partners. The system receives the company's reputation data provided by other transaction partners into a database and generates a presentation into the company's profile interface such that the data may be publicly displayed for other potential trading partners for the purposes of assessing credibility and trustworthiness.

For creating the company profile a user may click “New company page,” and the system may generate a fillable template via the user interface contain a number of fields that may filled-in with information concerning the company. A user created the company page may be automatically designated as the “owner” of the company page. The owner may also invite new members related to the organization granting them administrator access to perform actions in the platform on behalf of the organization.

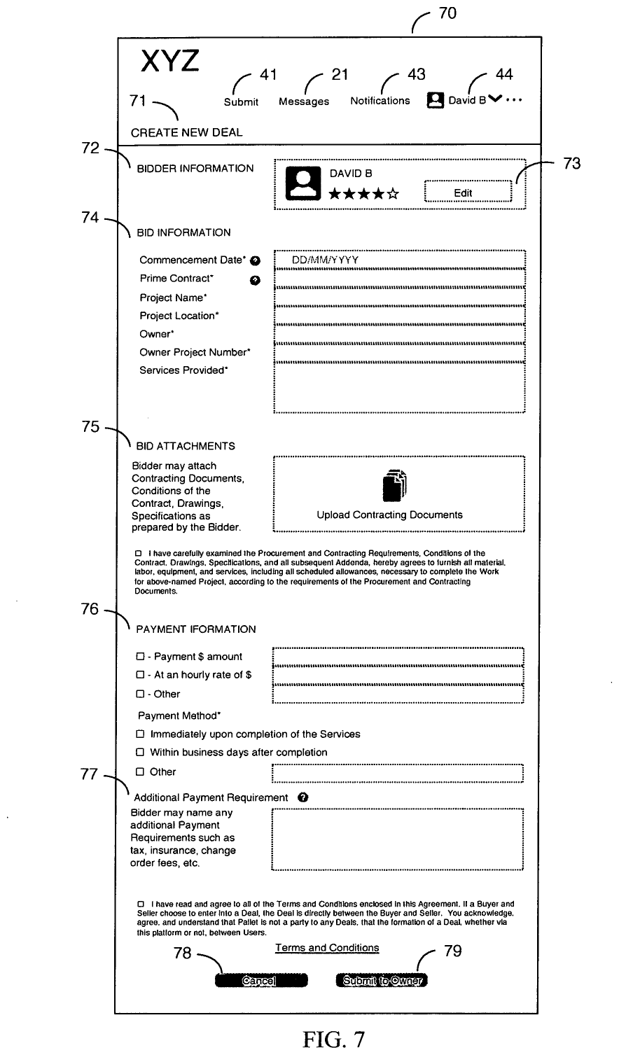

Contract/Deal Application FIG. 7

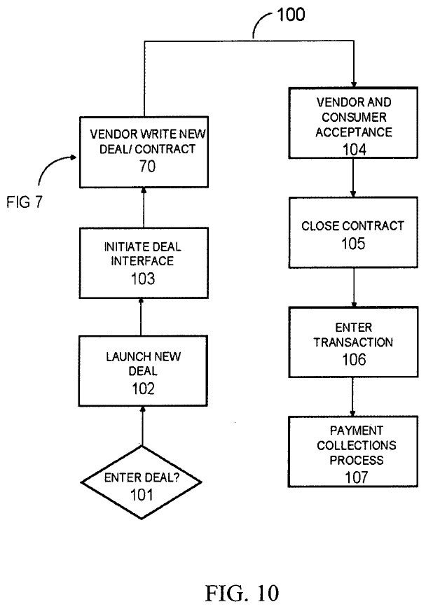

To further facilitate the ability for users to reach a deal for the purchase of an asset, the system provides services to generate a contract/deal for facilitating sales in the platform. As illustrated in FIG. 10 if the participants want to enter into a deal to finalize a purchase, then contract/deal application 70 may be generated. The deal page provides a user interface in which a consumer 31 may receive from the vendor 32 an appropriate contract for an agreement of sale.

The deal page 70 enables vendors 32 to design a deal, by clicking on “Create new deal” button 71, the contract may be a template that enables the bidder to specify the bidder information 72, bid information 74 (e.g. commencement date, prime contract, project name, project location, owner, owner project number and services provided), the payment information 76 (e.g. payment amount, at hourly rate, payment method, and additional payment requirements). To further facilitate the ability to create contracts the bidder may be provided with an option to upload bid attachments 75 such as contracting documents, terms and conditions of the contract, drawings, specifications, etc. After a vendor 32 has input all the contract information, the final step may be submitting the contract to the platform by selecting the corresponding “Submit” button 79. The system receives the contract data and may be stored in the proposal database 17 and may be provided to the potential consumer 31. If the participants reached an agreement on the necessary contract components, then they may finalize the deal by selecting the corresponding “buy” button for closing the transaction.

Transaction Application 26

After an agreement is reached between consumer 31 and vendor 32 as described in FIG. 10, the system provides services to complete a transaction for the purchase based on the calculated value of the vendor's asset. The platform system typically handles the collections process by supporting various collections methods performed by a third party, such as direct payment to the vendor 32, credit card and deposits into a bank account of the vendor 32. A transaction fee may be charged as a percentage of the total value of the transaction and is charged contingent upon completion of the transaction.

Alternatively, there is a commission on each purchase, such that a small part of the payment on each transaction is redirected to the present invention's owner. Purchase events are one of the points at which the present invention can make money. There are additional ways the system may generate profits. It may require an entry-fee subscription from members in order to be rewarded with greater services or access. Based on a subscription level there may be services opportunities, whereby users can get additional data, greater exposure, or other action from the system that rewards premium members.

Advertising Application 27

Furthermore, the system comprises with an advertising application 27 at which the present invention may generate profits. The advertisement may include content to promote products or services and may be displayed to a user typically via the presentation feed interfaces. The content of the advertisement may be proposed based on the location or interests selected by the user. For example, based on a knowledge of the user's location, advertisements may be selected which are geographically relevant to the user. Additionally, the advertisement may be selected based on the assets which the user has indicated he would like to purchase such as products or services that match the interests of the user.

Project Management Application 80

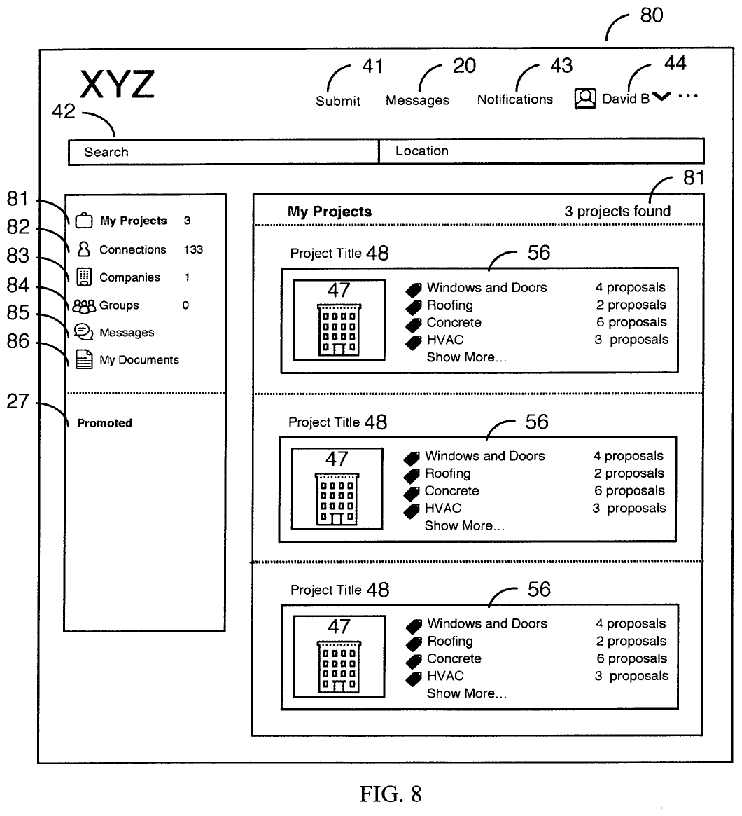

Another object of the invention may offer a system for management and organization of project's data in a consolidated application. As described in this document, project owners may often receive plurality of proposals and may need to coordinate with multiple parties including sharing documents, proposals, contacts and other data associated with the project. Such management capabilities assist project owners, individuals or teams, in effectively keeping all their information organized, wherein data related to projects can be stored and presented by groups and classifications for user visualization on an interactive user interface in a consolidated application. Preferably, as illustrated in FIG. 8 a user may be provided with an option to keep information organized by activities, e.g. “My projects” 81, Connections 82, Companies 83, Groups 84, Project proposals 56, Messages 85, Documents 86, etc. Upon clicking “My projects,” button 81, the application system is designed to present one or more project activities and information, in a user interface web page referred as “my projects” 80. The user is able to view a list of one or more projects. This information is captured in a hierarchy, wherein a project is the highest level while each project may have a list of one or more “project proposals” 56 relating to it for example, windows, roofing, kitchen cabinets, etc.

The web page 80 may also contain a presentation of project titles 48 and thumbnails images 47 that have identified in the database 14. The web page also comprises of various controls to manage the information, information may be added, arranged, combined, deleted or shared. In addition, as illustrated in FIG. 8, the left side bar may include promoted content 27 to advertise products or services that may be relevant to the user, presented based on a knowledge of the location or/and interests of the project owner.

Notifications Application 28

Another object of the invention may enable notification application 28, configured to notify a user of information related to event after it has taken place, for example, messages, proposals, page views, shares, etc. The notification is provided as an automated process with real-time updates in accordance to: (1) user database 15; (2) listing database 16; (3) proposals database 17; and/or (3) platform metadata. The application may provide a user option to control the desirable data characteristics for generating notifications, by inserting data to a profile setting during an account creation process, in which will be stored within a user profile. An interactive user interface may be provided for inputting number of factors concerning user preferences such as location, job details, and preferences and background.

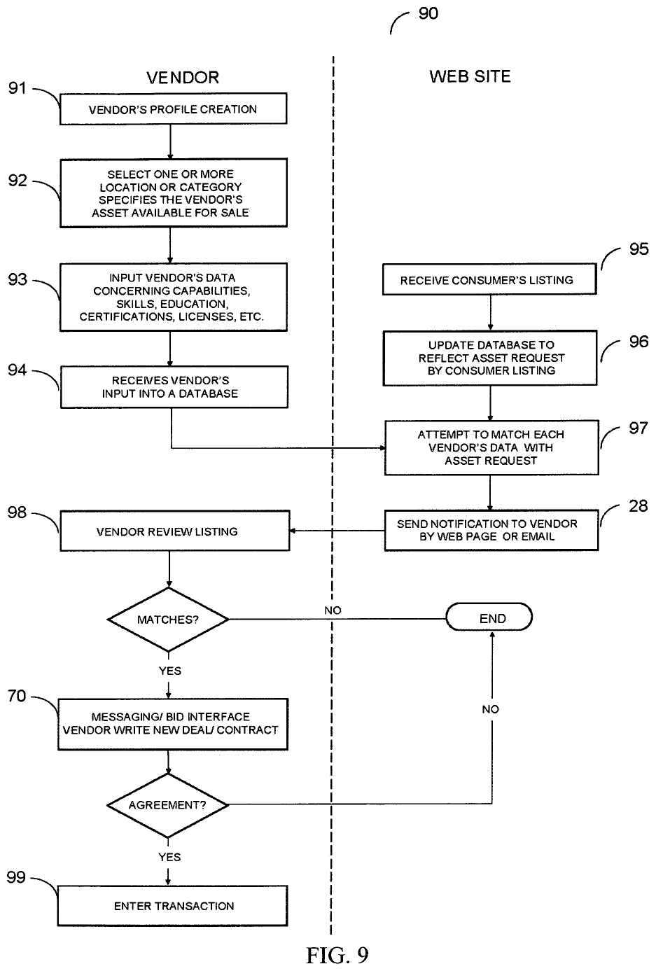

Furthermore, the system may operate a matching application 90 in which, utilize the data for providing potential matches between consumer 31 in need of a good or service, and suitable vendor 32. The matching application 90 may be activated as an automated process as illustrated in FIG. 9 and assists customers to facilitate efficient search, in which parties can be brought together by an automated process for procuring goods and services.

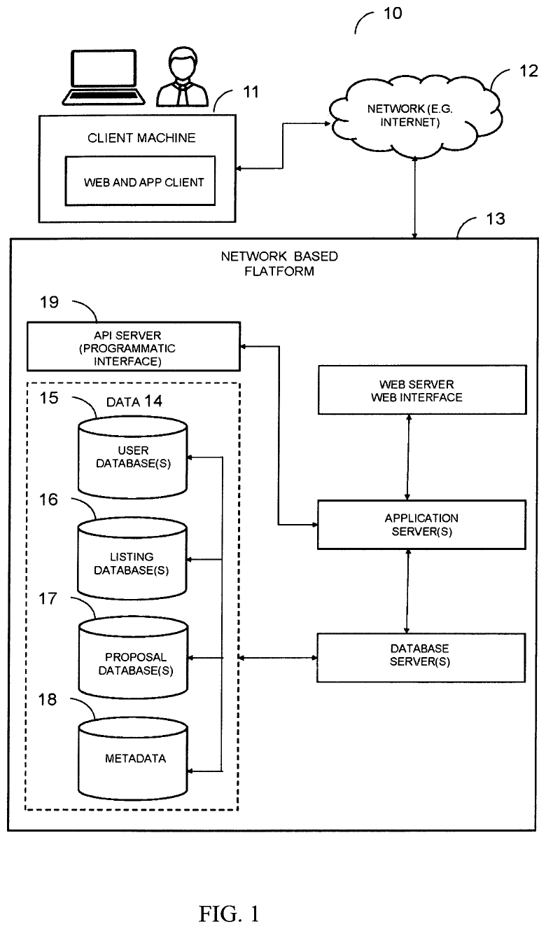

More specifically, the method may transmit a notification to the vendor for indicating when a match has been found between the asset request and the vendor's profile. The data 19 is drawn from a database 14 for determining one or more common links in accordance with consumers 31 and vendors 32, upon customer's asset request drawn from the listing database 16, and vendors data, drawn from the user database 15. Vendor's data can be entered during an account creation 23 process and can be stored within a vendor profile. This information might be captured for example, in the data illustrated in FIG. 1, and contain relevant data concerning the vendor capabilities, in which can include skills, education, certifications, licenses, preferred wage, and/or ratings and reputation 58 from previous jobs. In some embodiments, vendors 32 can set their availability to indicate if he or she is available on-demand for immediate asset requests. Preferably, this information is rendered into one or more data parameters that facilitate the process of alerting vendors to any pertinent business opportunities.

Analytics Application 29

Another object of the invention may offer analytics application 29 engine which assist users in tracking the behavior and information of events after they have taken place. For example, proposals, views, shares, etc. can be analyzed to measure what happened based on the data retrieved. Using diagnostic analytics and/or predictive and proactive analysis is useful to users that wish to determine why an event/result occurred and involves learning what did/did not work, discover trends and patterns of behavior in the data, as such, can then be used to provide insight and/or suggest future events. The analytics application 29 engine is designed to present dashboards, and reports for user visualization on an interactive user interface.

In one embodiment, the analytics application 29 engine may be used by a project owner to view different reports or performance metrics related to a particular asset request and prospective proposals. In another embodiment, the analytics application 29 engine may be used by a vendor 32 to analyze performance of proposals offered to customers. The vendor 32 may benefit from data that provides insights on customer engagement of a given proposal, analyze patterns in the data and monitor how customers respond to proposals. The information gathered can then be used for example, to aid vendors 32 in increasing customer engagement. As another example the analytics engine may be used by the vendor 32 to analyze the impact of a given advertainment in which the data can provide statistics, diagrams, and other information that can be used to track marketing performance indicators. That is to say, using analytics engine for marketing content can be made as to factors or key attributes to identify views, track advertising clicks and measure visits to vendor's website.

### CONCLUSION

Although the invention has been described in terms of certain embodiments, other embodiments will be apparent to those of ordinary skilled in the art, including embodiments that do not include all of the features and benefits set forth herein.

A method for facilitating exchanges of construction assets via consolidated platform, comprising:

What is claimed is:

1. The method of claim, wherein potential vendors are able to view listings of construction asset requests which users who are potential customers submit through the platform. Construction asset can mean a good, a service, or a combination of goods and services, comprising
(a) receiving procurement requests from potential customers such that the request includes an indication of one or more construction assets which the user desires to purchase;
(b) generating a browsable presentation feed from a plurality of source feeds, based on the listing information, wherein such a feed generates listings continuously in real time and includes a user option to browse platform listings filtered by, at least
i. selected asset category, and
ii. selected asset location, and;
(c) a method of identifying the current geographic location of the user.

2. Providing, in association with the feed application, a user option to view a listing within the listing detail page, in conjunction with a display comprising reference information of, at least:
(a) images and construction documentation of relevant information uploaded for inclusion within the listing,
(b) a detailed description of the construction asset request, and
(c) a detailed description of the construction project including,
i. project name,
ii. company name,
iii. project location,
iv. recent listing history,
v. project summary (e.g. type, status, estimated start date), and;
vi. listing owner's profile.
(d) the project location is presented on a geographic map display in which generated in accordance with the received address information. In particular, a visualization of the geographic project location for identifying geographic area on a user interface.
(e) the listing owner's profile information can be displayed on demand so that the user account data is presented together with personal identity, user history, rating parameter.

3. A method, further comprising a listing creation component that enables customers to generate listings relating a construction asset they wish to buy. Such component enables customers to publish the listing through the platform in a browsable presentation feed. The method of claim, wherein a user creates a listing, comprising the steps of:
(a) providing construction project information,
(b) providing construction documentation, and
(c) specifying a construction asset category which a user is able to specify through
i. a search engine, and
ii. a browse tree interface.

4. Providing, in association with the listing creation, a method of assisting users in locating construction assets that are arranged within a database system by construction category, such that users can perform asset searches, through at least:
(a) a search engine interface, and
(b) a browse tree interface organized into predetermined categories.

5. A method for a listing management application, wherein users are able to perform one or more actions on the listing that typically occur post-listing, comprising user options of, at least:
(a) editing the listing content,
(b) providing further listing content,
(c) enrolling other users to be administrators for that listing if the user has sufficient permissions (e.g., if the user is designated as a “owner” of that listing for the system), and
(d) removing the listing,
(e) archiving the listing.

6. A method wherein the authentication application facilitates secured access by users for conducting activity through the platform, involving use of a secure application account through user credentials, comprising:
(a) receiving a login request from a user, wherein the user credentials are validated to authentication data indicative of a particular user identity;
(b) determining the attributes of a particular user identity which grant the user certain rights for performing functions through the platform, and;
(c) communicating with a client application to authenticate a user account and authorize use of the platform's functions.

7. A method for a messaging application, wherein users are able to exchange messages with one or more users through the platform in a chat environment, comprising a user option to bid or negotiate a transaction for the purchase of an asset in conjunction with an option of, at least:
(a) initiation of a chat conversation,
(b) uploading attachments for sharing with the other participant,
(c) addition of a new participant to a conversation, and
(d) removal of participants from the conversation.

8. A method for building a reputation profile, based on feedback from one or more of the transaction participants, on performance characteristics of the transaction event, and; The method of claim further comprising publishing the reputation profile through a user interface of the platform, wherein the reputation profile represents a trust indicator of the transaction participants.

9. A method for providing management and organization capabilities, wherein data related to user's projects can be stored by groups in a consolidated application.
(a) The data is captured in a hierarchy, wherein a project is the highest level while each project may have a list of one or more activities relating to it.
(b) A user may be provided with an option to perform various controls to manage the data, comprising information may be;
i. added,
ii. arranged,
iii. combined,
iv. deleted, and/or;
v. shared,
(c) A user may be provided with an option to keep information organized by activities, comprising;
vi. projects,
vii. connections,
viii. companies,
ix. groups,
x. project proposals,
xi. messages, and
xii. project documents.

10. A method for providing a transaction application wherein the customer and vendor negotiate and complete a sale of the selected construction assets, comprising:
(a) providing a user option to complete a transaction for the purchase of a construction asset by entering the transaction initiation system, referred to as the “transaction application”;
(b) displaying, through a graphical user interface of the transaction application, a contract to specify terms and conditions regarding the proposed transaction;
(c) receiving customer and vendor acceptance indicating a willingness to proceed with the proposed transaction entered through a graphical user interface of the transaction application; and
(d) arranging of payments for a sale of one or more construction assets such that collections methods are performed by a third party, comprising a user option of
i. a direct payment to the vendor,
ii. a credit card, or
iii. a deposit into a bank account of the vendor.

11. A method for providing an electronic advertising system offering a plurality of advertisements categorized by content including advertised services, advertised products, or combinations thereof wherein advertisement placement is targeted for one or more users based on a consumer profile database of consumer information, consisting of:
(a) recent purchases of a consumer,
(b) business and profession of a consumer,
(c) demographics of a consumer, and
(d) recent product or service inquiries of a consumer or combinations thereof.

12. A method for providing corporate accounts which enable individual users to be associated with an organization and provide for a plurality of participants to gain access to perform actions in the platform on behalf of an organization. A company profile account facilitates secured access for conducting activity through the platform, involving a user option for inputting relevant data concerning the company, comprising the company's:
(a) name,
(b) location,
(c) contact information,
(d) image of company logo,
(e) user identifiers for authorized employees and agents,
(f) social media links, and
(g) other relevant company information.

13. A method of claim, wherein a company profile interface further comprising the company's reputation data received by other transaction partners into a database, such that generates the data into a presentation via company's profile interface.

14. A method for providing notification application configured to notify a user of information related to event after it has taken place. consisting of:
(a) The notifications are provided as an automated process in accordance to user data as well as offers the user with real-time updates, comprising:
xiii. Recent proposals,
xiv. messages received
xv. page views, or
xvi. page shares.
(b) The method involving a user option to control the desirable profile characteristics for generating notifications once the user account has been created.
(c) An interactive user interface for inputting number of factors concerning user preferences, comprising:
xvii. location,
xviii. job details, or
xix. background.

15. A method wherein the user data is utilized for providing potential matches between customers in need of a good or service, and suitable vendor through the platform. The data is drawn from a large database as an automated process for determining one or more common links in accordance with customers and vendors, upon,
(a) listing creation by a customer for asset request, and;
(b) vendors data drawn from the vendor's profile.
(c) Vendors data can be entered during an account creation process and can be stored within a vendor profile. for inputting relevant data concerning the vendor capabilities, comprising:
xx. skills,
xxi. education,
xxii. certifications, licenses,
xxiii. ratings from previous jobs, or
xxiv. availability to indicate if he or she is available on-demand for immediate asset requests.
(d) The notification application can be utilized as an automated process wherein the method transmits a notification to the vendor for indicating when a match has been found between the service request and the vendor's profile.

16. A method wherein analytics engine generates different reports or performance metrics related to events within the platform, after they have taken place, and; The method of claim further comprising analytics engine that can be used by customers to track behavior and information, in which can be analyzed to measure what happened based on the data retrieved.
(a) The method involving a user option to present dashboards, and reports for user visualization on an interactive user interface for inputting relevant data concerning events occurred, comprising:
xxv. proposals,
xxvi. page views,
xxvii. marketing engagement,
xxviii. advertisement's clicks, or
